(19) United States
(12) Patent Application Publication
(10) Pub. No.: US 2007/0240780 A1
(43) Pub. Date: Oct. 18, 2007

(54) ADHESION PROMOTING END TREATMENT SYSTEM AND METHOD FOR GIRTH-WELDS

(75) Inventors: Mark K. Nestegard, Mendota Heights, MN (US); Mark T. Anderson, Woodbury, MN (US); Dawn V. Muyres, Austin, TX (US); Mario A. Perez, Burnsville, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/697,965

(22) Filed: Apr. 9, 2007

Related U.S. Application Data
(60) Provisional application No. 60/744,964, filed on Apr. 17, 2006.

(51) Int. Cl. F16L 9/14

(52) U.S. Cl. 138/145; 138/146

(57) ABSTRACT

A pipe includes an outer surface with a polyolefin-based protective coating covering a substantial portion thereof In addition, an end wrap material is disposed on the protective coating proximate to an end of the pipe, where the end wrap material is bondable to a polymer-containing protective material, such as a heat shrink sleeve or cover. The end wrap material can bond a heat shrink cover or sleeve in place over a girth-weld, thus substantially reducing the likelihood of the disbandment or movement of the sleeve from the welded pipe ends over time.

### CROSS REFERENCE TO RELATED APPLICATION

This application claims the benefit of U.S. Provisional Patent Application No. 60/744,964, filed Apr. 17, 2006, the disclosure of which is incorporated by reference herein in its entirety.

### FIELD OF THE INVENTION

The present invention relates to an adhesion promoting end treatment system and method for protecting girth-welds.

### BACKGROUND

In the oil and gas industry, transmission pipelines are laid to transport a variety of liquids and gases. These pipelines are formed of many miles of steel piping that can vary from 8 to 80 inches in diameter. Depending on the location and environmental conditions, the pipe may be installed above ground or buried. The exterior of the pipe can be in contact with highly corrosive environments, such as seawater, soil, rock, air, or other gases, liquids or solids.

To protect the pipes from stresses due to exposure from often extreme environmental conditions, the pipe exteriors are generally coated with a protective coating in the factory, not the site where the pipes are to be installed. Conventional protective coatings are described in J. A. Kehr, “Fusion-Bonded Epoxy (FBE): A Foundation for Pipeline Corrosion Protection”, NACE Press (Houston, Tex.), 2003 (see e.g., Chapter 4 and pages 234-246). For example, a three layer protective coating, that includes a fusion bonded epoxy, an adhesive, and a polyolefin topcoat, is typically applied to pipe in the factory.

However, the pipe ends are not coated, with about 6 inches (axial length) of uncoated pipe at each end, where pipe segments are welded together. The resulting welds are referred to as “girth-welds” or “field joints” and are not coated with a protective coating before the installation is complete.

As such, girth-welds can be susceptible to corrosion and other environmental effects. Several methods to protect the girth-weld are known. The most frequently used and accepted method is utilizing a heat shrink sleeve to cover the girth-weld. However, conventionally installed heat shrink sleeves tend to provide diminished protection prior to the end of the expected service lifetime as the sleeves are susceptible to moving away from the weld, thereby leaving the joint unprotected. This deterioration can be caused, at least in part, by the inherent properties of the polyolefin topcoat, a low surface energy and an inert surface.

One conventional approach to better adhesion involves “roughing” the ends of the mainline coating in the field. A problem with this approach is that the roughening is not uniform or consistent and the roughening doesn't change the chemical incompatibility of the pipe ends and the adhesive that may be applied by the sleeve manufacturer. Another approach is to heat the ends of the mainline coating with a torch. This approach can also be problematic because the heating may not be uniform and may not lead to sufficient long-term adhesion in some cases. Another approach is the use of fluorine gas to chemically alter the pipe surface, but exposure to fluorine gas is a known danger. Another approach is to apply an adhesive in the field prior to activating the heat shrink. However, temperature limitations are a likely cause to poor high shear adhesion. Other approaches (and their problems) are described in J. A. Kehr, “Fusion-Bonded Epoxy (FBE): A Foundation for Pipeline Corrosion Protection”, NACE Press (Houston, Tex.), 2003 (see e.g., Chapter 7).

### SUMMARY

In one aspect, the present invention provides a pipe having an outer surface with a polyolefin-based protective coating covering a substantial portion thereof. In addition, an adhesion promoting end treatment material is disposed on the protective coating proximate to an end of the pipe, where the adhesion promoting end treatment material is bondable to a polymer-containing protective cover material. In a preferred aspect, the adhesion promoting end treatment material comprises at least one of EVA, formulated EVA hotmelt adhesive, and a polyethylene copolymer, for example, ethylene maleic anhydride, ethylene carboxyl acid or ethylene acrylic acid.

In another aspect, the present invention provides a pipe system comprising first and second pipes having first and second ends welded together forming a girth-weld. A protective coating covers a substantial portion of an outer surface of the first and second pipes, the protective coating comprising a polyolefin-based coating. An adhesion promoting end treatment material is disposed on the protective coating proximate to the pipe ends of the first and second pipes. The pipe system further includes a polymer-containing protective cover material disposed over the girth-weld and bondable to the adhesion promoting end treatment material.

In another aspect, the present invention provides a method of forming a protected girth-weld. The method includes providing first and second pipes having first and second ends, the first and second pipes including a protective coating covering a substantial portion of an outer surface thereof, the protective coating comprising a polyolefin-based coating, and further including an adhesion promoting end treatment material disposed on the protective coating and proximate to the pipe ends of the first and second pipes. The first and second pipe ends are welded together to form the girth-weld. An expanded (heat recoverable) polymer-containing protective cover material, such as a heat shrink material, is disposed over the girth-weld, where the polymer-containing protective cover material is bondable to the adhesion promoting end treatment material. The polymer-containing protective cover material can then be shrunk or otherwise activated over the girth-weld.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

FIG. 1 is a schematic representation of a pipe end having an adhesion promoting end treatment material applied near the end of the pipe according to an aspect of the present invention.

FIG. 2 is a schematic representation of a girth-weld protected with a protective covering according to an aspect of the present invention.

FIG. 3 is a schematic illustration of a process for applying an adhesion promoting end treatment to a pipe during factory assembly according to an aspect of the present invention.

These figures are not drawn to scale and are intended only for illustrative purposes. While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

Aspects of the present invention relate to an adhesion promoting end treatment system and method for protecting girth-welds. In particular, an adhesion promoting end treatment material can be applied, for example, in film or molten form, to the ends of pipes during the pipe manufacturing process in the factory. The factory applied adhesion promoting end treatment materials can be automatically applied to a pipe end immediately after a protective (e.g., three-layer) coating process and before the cutting and quenching of the protective coating applied to the pipe. After welding of the pipe ends in the field to form the girth-weld, a heat recoverable polymer-containing protective cover material, formed as e.g., a heat shrink sleeve or cover, can be placed over the girth-weld. The adhesion promoting end treatment material can thus provide a preferable adhesive surface for the polymer-containing protective cover material to adhere to in the field, as polymer-containing protective cover materials do not adhere well to standard protective coatings, such as, for example, polyolefin, especially polyethylene, coatings.

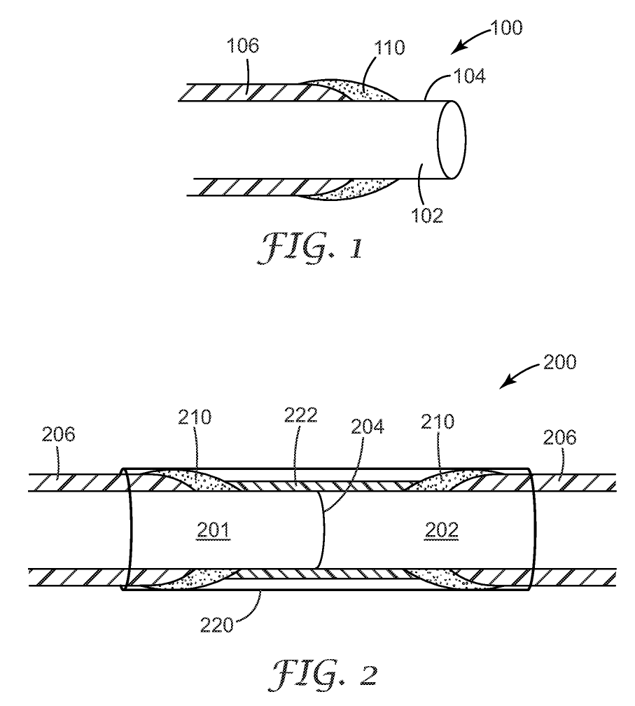

FIG. 1 shows a first aspect of the present invention, a side view of pipe end 100. Pipe end 100 can be formed from a pipe material 102, such as steel. Pipe end 100 also includes an outer coating 106. Outer coating 106 is a conventional protective coating, such as a polyolefin-based coating. In an exemplary embodiment, protective coating 106 comprises a three-layer coating having an epoxy, an adhesive and a polyolefin top coat that are melt-fused together on the prepared pipe material 102. The epoxy layer can be either a 2-part liquid system or a fusion bonded epoxy powder. For example, the epoxy layer can be prepared from a commercially available powdered SCOTCHCAST Resin 226N (available from 3M Company, St. Paul, Minn.). The thickness of such a layer can be from about 0.05 mm to about 1.0 mm. The adhesive layer frequently utilizes a maleic-anhydride-grafted adhesive. This material is generally extruded and wrapped on top of the epoxy layer, with a thickness of about 5 mils to about 10 mils. The topcoat can be one of several types of polyolefin materials (e.g., LDPE, MDPE, HDPE, PP) depending on the conditions and needs of the pipeline. The top coat is extruded and wrapped on top of the adhesive layer. The topcoat is approximately 40 mils or greater. Exemplary three layer coating formulations 106 include those described in the Kehr reference, cited above.

Pipe end 100 further includes an uncoated portion 104. After the coating process is complete (see details below), a portion of the pipe coating, about 2 to 10 inches in length from the pipe end, is removed, stripped, or sanded off to help promote better welding in the field. This stripping operation can be performed in the factory.

In an exemplary embodiment, the pipe end 100 further includes an adhesion promoting end treatment material 110 that is applied to the three layer coating 106 proximate to the pipe end region. The adhesion promoting end treatment can be a one-layer or multilayer construction. For example, a one-layer adhesion promoting end treatment can comprise at least one of: a polyolefin with a lower melting point than the mainline (topcoat) polyolefin coating, for example, a low-density polyethylene; EVA; formulated EVA hotmelt adhesive; a polyethylene copolymer, for example, ethylene maleic anhydride, ethylene carboxylic acid; and ethylene acrylic acid.

In another example, an exemplary multilayer adhesion promoting end treatment can include a “weldable” polyolefin layer and one or more adhesion promoting end treatment layers. The weldable polyolefin layer is bondable to the mainline polyolefin, especially when both are in a molten form, as in the mainline coating process (described below). The adhesion promoting end treatment layer or layers can comprise, for example, at least one of: a low-density polyethylene, EVA, formulated EVA hotmelt adhesive, a polyethylene copolymer, for example, ethylene maleic anhydride, ethylene carboxylic acid and ethylene acrylic acid.

As described in more detail below, in an exemplary aspect, the adhesion promoting end treatment material 110 can comprise a polymer film that is similar in structure to the polyolefin topcoat and that can bond a polymer-containing protective cover material, such as a heat shrink material, to the protective coating. The adhesion promoting end treatment material 110 can be applied to the pipe end region, as part of a manufacturing process, by, e.g., coextrusion with the mainline polyolefin, extrusion from multiple dies, by lamination of a nonwoven or woven film or a multilayer polyolefin/adhesion promoter construction, or by spraying the adhesion promoting end treatment on the polyolefin topcoat in the factory. The adhesion promoting end treatment material 110 adheres to the three layer coating 106 and to a polymer-containing protective cover material that is applied in the field and is utilized to protect the girth-weld.

As mentioned above, a conventional method to protect a girth-weld is utilizing a polymer-containing protective cover material, such as a heat shrink sleeve, to cover the girth-weld. However, conventionally installed heat shrink sleeves tend to provide diminished protection prior to the end of the expected service lifetime as the sleeves are susceptible to moving away from the weld, thereby leaving the joint only partially protected or unprotected. A current problem is that conventional heat shrink materials do not adhere well to conventional three layer coatings. However, FIG. 2 shows another exemplary embodiment of the present invention, a pipeline 200 having a girth-weld with a polymer-containing protective cover material, such as a heat shrink protective cover or sleeve. In this exemplary embodiment, a girth-weld 204, joining pipe ends 201 and 202, can be protected by an exemplary heat shrink cover 220. Heat shrink cover 220 can comprise a pre-expanded EPDM rubber or cross-linked polyethylene materials. The heat shrink material can adhere to the adhesion promoting end treatment material 210, which has been applied to both pipe ends 201 and 202 in the pipe-coating factory. The heat shrink cover 220 preferably surrounds the entire girth-weld. Thus, the added adhesion of material 210 can prevent the heat shrink from movement (relative to the pipe surface) after application. Although FIG. 2 shows a heat shrink material 220 as an outer protective cover for girth-weld 204, other types of polymer-containing protective cover materials or wraps can be utilized, as would be understood by one of ordinary skill in the art given the present description.

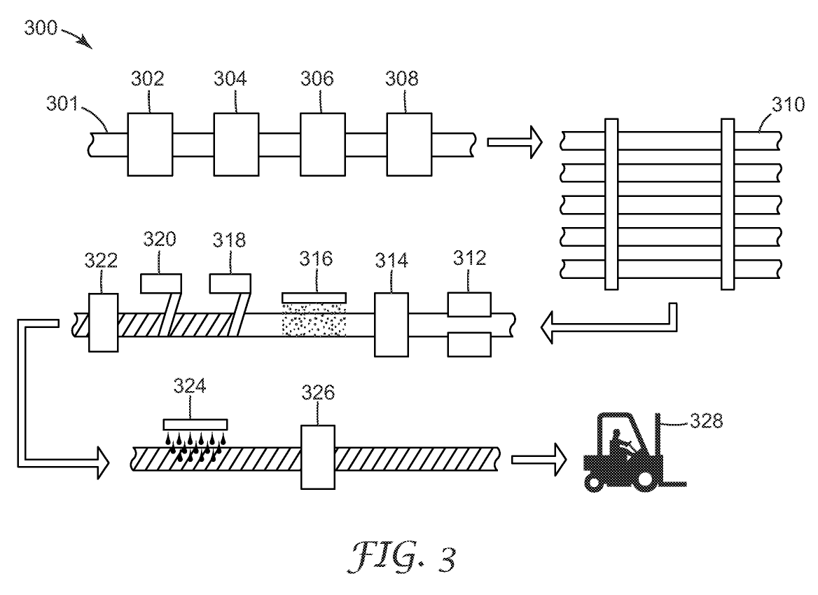

The adhesion promoting end treatment material 110 or 210 can be applied to a pipe end as part of a pipe coating process, in accordance with the process shown in FIG. 3. In a pipe manufacturing assembly line, a pipe 301 can be formed using conventional techniques such as described in described in J. A. Kehr, “Fusion-Bonded Epoxy (FBE): A Foundation for Pipeline Corrosion Protection”, NACE Press (Houston, Tex.), 2003 (see e.g., pages 108-120). As shown in FIG. 3, pipe 301 undergoes a pre heating step 302, which can heat the pipe above the dew point. The preheated pipe is then blast-cleaned in step 304 using a conventional blast cleaning technique. For example, the pipe can be precleaned of dirt, grease and oil according to SSPC-SPC standards. The pipe is typically blasted with cast-steel shot or cast-steel grit to a near-white-metal condition in accordance with specifications—NACE NO. 2/SSPC-SP 10.

Optionally, the pipe 301 outer surface can be further cleaned using a grinding technique 306 that grinds surface defects. The pipe surface can be inspected in step 308.

The pipe segments 301 are transported end to end on the assembly line in step 310 for a final surface treatment 312, where the pipe can be acid washed to remove any remaining contamination. Prior to application of a protective coating, pipe segments 301 are heated in step 314. One preferred heating technique is the use of induction coils to bring the surface temperature of the pipe to an elevated temperature of about 180° C. to about 240° C.

A protective coating is then applied to the outer surface of pipe 301. In a preferred aspect, the protective coating is a three-layer coating such as described above. As would be understood by one of ordinary skill in the art given the present description, other protective coatings, such as two-layer coatings, and those described in the Kehr reference, cited above (see e.g., Chapter 4 and pages 234-246) (incorporated by reference herein), can also be utilized as the protective coat for pipe 301.

In an exemplary embodiment, in step 316, an epoxy layer, such as a fusion bonded epoxy (FBE) powder is applied to the heated outer surface of pipe 316. In a preferred aspect, the FBE is applied through an electrostatic process. Once the FBE is applied to the heated pipe, it melts and flows onto the metal surface, resulting in a coating having a thickness of about 4 mils to about 10 mils. In step 318, an adhesive layer, such as a copolymer, is applied to the FBE. Preferably, the copolymer is applied using a conventional extrusion process, as the pipe 301 is rotated during the coating process. In step 320, the polyolefin top coating is applied. Preferably, a polyolefin, such as polypropylene or polyethylene, is applied using an extrusion process.

In one aspect of the invention, in step 322, an adhesion promoting end treatment material is applied to at least a portion of the coated pipe surface, at or near the pipe ends. The adhesion promoting end treatment material, which can be a one layer or multilayer construction, can be applied as a film or as a molten material. In one aspect, a film, such as a homogeneous polymer film, can be applied to the heated polyolefin layer using an extrusion process, as the adhesion promoting end treatment material can sufficiently adhere to the molten polyolefin. The residual heat from the pipe 301 can melt the adhesion promoting end treatment material and permit it to fuse with the polyolefin as they both cool.

For example, the homogeneous polymer film can be applied using a lamination process. For example, a two-foot wide film could be laminated to straddle the joint between the pipe ends. The film can either be pre-sectioned in a length equal to the pipe circumference or a continuous roll that can be sectioned or cut after one full rotation of the pipe. This adhesion promoting end treatment material film can be laminated to the polyolefin coated pipe in an intermittent fashion.

In a further alternative, the adhesion promoting end treatment material comprises a homogeneous polymer film that can be coextruded with the polyolefin coating.

In a further alternative, the adhesion promoting end treatment material is applied to the protective coating directly as a molten material instead of as a film. For example, a coating die or melt spray system can apply the molten material, followed by a wipe process. The molten material is preferably applied intermittently to only cover a portion of the pipe end, for example about 8 to about 16 inches on each pipe end.

In a preferred aspect, the adhesion promoting end treatment material comprises a one-layer or multilayer construction, such as described above. In a further preferred aspect, the adhesion promoting end treatment material has a chemical structure similar to that of the top coating it is applied to (e.g., a polyethylene or a copolymer of polyethylene). For exemplary coextruded or laminated films, one side of the adhesion promoting end treatment material can comprise a polyethylene or a copolymer of polyethylene and the other side can comprise a textured polymeric material, such as, PVC, phenoxy resin, polycarbonate, nylon, or polypropylene, which adheres to mastic or modified polyolfin materials that comprise the heat shrink adhesive. The texture can be imparted by embossing, patterned printing, subtractive methods, such as grinding or cutting. As would be understood by one of ordinary skill in the art given the present description, the formulation of the adhesion promoting end treatment material can be tailored to the particular type of girth-weld cover being utilized in the field. For example, as noted above, exemplary adhesion promoting end treatment materials can include EVA, formulated EVA hotmelt adhesive, or other copolymers of polyethylene.

Alternatively, for girth-weld cover systems that utilize a thermoset corrosion coating as an adhesive between the polyethylene coated pipe and the girth-weld wrap or cover, the adhesion promoting end treatment material can comprise a laminated multilayer construction such as EVA or polyethylene, disposed on one side and a fabric disposed on the other. The fabric can comprise a woven, non-woven, or knit material. This fabric wrap can wrapped around the pipe end and pressed into the molten polyolefin while still at elevated temperature.

Referring back to FIG. 3, after application of the adhesion promoting end treatment material, the coated pipe is quenched or cooled in step 324. After the quenching step, the end portions of each pipe segment can be stripped of the three-layer coating. The pipe can then be inspected in step 326 prior to stockpiling or shipment to the field in step 328.

Referring back to FIG. 2 for illustration, in the field, prior to welding to pipe ends 201 and 202 together, a polymer-containing protective cover material, such as an exemplary heat shrink sleeve 220, can be slid down one pipe near the welding location. The pipe ends can then be welded together using a conventional welding process to form a girth-weld 204. After welding, optionally, the girth-weld area can be further cleaned. Additionally, a field-applied protective coating 222 can be applied to the girth-weld. This optional coating 222 can be a liquid epoxy, such as Scotchcast 323 available from 3M Company, St. Paul, Minn.

After the optional coating 222 is applied and/or at least partially cured, sleeve or cover 220 is slid down to cover weld 204. In an alternative aspect, adhesion promoting end treatment material 210 is applied to the pipe ends as a pressure sensitive adhesive, such as a dual-sided tape. An exemplary dual sided tape is a VHB tape, available from 3M Company (St. Paul, Minn.). The adhesion promoting end treatment material 210 can further include a release liner that is removed just prior to placement of the heat shrink sleeve or cover 220 over the girth-weld 204. The release liner can cover the adhesive wrap for extra protection during shipping of the pipe.

To conform a heat shrink sleeve 220 to the surface of the girth-weld 204, heat is applied (e.g., via a hot air gun or torch) to sleeve 220. In one exemplary embodiment, the protective sleeve comprises a sheet that is wrapped around the pipe (to cover the girth-weld), then sealed longitudinally (e.g., by heating the overlap region). The sleeve can then be shrunk by applying heat. A technician, for example, can start at the center of the sleeve (with the weld seam being directly underneath the sleeve) and can seal the sleeve around the pipe by heating radially, working outward (longitudinally) from the middle—alternating in each direction—to completely shrink the sleeve. The adhesion promoting end treatment material 210 thus bonds the heat shrink cover or sleeve 220 in place, thus substantially reducing the likelihood of the disbandment or movement of the sleeve 220 from the pipe ends.

While the present invention has been described with a reference to exemplary preferred embodiments, the invention may be embodied in other specific forms without departing from the scope of the invention. Accordingly, it should be understood that the embodiments described and illustrated herein are only exemplary and should not be considered as limiting the scope of the present invention. Other variations and modifications may be made in accordance with the scope of the present invention.

It is claimed:

1. A pipe having an outer surface, comprising:
a protective coating covering a substantial portion of the outer surface, the protective coating comprising an polyolefin coating; and
an adhesion promoting end treatment material disposed on the protective coating and proximate to an end of the pipe, the adhesion promoting end treatment material bondable to a polymer-containing protective cover material.

2. The pipe according to claim 1, wherein the adhesion promoting end treatment material is bondable to a heat recoverable polymer-containing material.

3. The pipe according to claim 1, wherein the adhesion promoting end treatment material comprises a multilayer construction.

4. The pipe according to claim 3, wherein the multilayer construction comprises:
a weldable polyolefin layer; and
at least one of a low-density polyethylene, EVA, formulated EVA hotmelt adhesive, a polyethylene copolymer, ethylene carboxylic acid, and ethylene acrylic acid.

5. The pipe according to claim 3, wherein the multilayer construction comprises a laminated multilayer construction having at least one of EVA and polyethylene disposed on a first side and a fabric disposed on a second side.

6. The pipe according to claim 5, wherein the fabric comprises one of a woven, a non-woven, and a knit material.

7. The pipe according to claim 1, wherein the adhesion promoting end treatment material comprises at least one of a low-density polyethylene, EVA, formulated EVA hotmelt adhesive, a polyethylene copolymer, ethylene carboxylic acid, and ethylene acrylic acid.

8. The pipe according to claim 1, wherein the adhesion promoting end treatment material comprises a pressure sensitive adhesive.

9. The pipe according to claim 8, wherein the pressure sensitive adhesive comprises a dual sided tape, wherein at least one side includes a release liner.

10. A pipe system, comprising:
first and second pipes having first and second ends welded together forming a girth-weld;
a protective coating covering a substantial portion of an outer surface of the first and second pipes, the protective coating comprising a polyolefin coating;
an adhesion promoting end treatment material disposed on the protective coating and proximate to the pipe ends of the first and second pipes; and
a polymer-containing protective material disposed over the girth-weld and bondable to the adhesion promoting end treatment material.

11. The pipe system according to claim 10, wherein the adhesion promoting end treatment material is bondable to the polymer-containing protective material.

12. The pipe system according to claim 10, wherein the adhesion promoting end treatment material comprises a multilayer construction that includes:
a weldable polyolefin layer; and
at least one of a low-density polyethylene, EVA, formulated EVA hotmelt adhesive, a polyethylene copolymer, ethylene carboxylic acid, and ethylene acrylic acid.

13. The pipe system according to claim 10, wherein the adhesion promoting end treatment material comprises a multilayer construction, wherein the multilayer construction comprises:
a laminated multilayer construction having at least one of EVA and polyethylene disposed on a first side and a fabric disposed on a second side, wherein the fabric comprises one of a woven, a non-woven, and a knit material.

14. The pipe system according to claim 10, wherein the adhesion promoting end treatment material comprises a dual sided tape, wherein at least one side includes a release liner.

15. A method of forming a protected girth-weld, comprising:
providing first and second pipes having first and second ends, the first and second pipes including a protective coating covering a substantial portion of an outer surface thereof, the protective coating comprising an polyolefin coating, and further including an adhesion promoting end treatment material disposed on the protective coating and proximate to the pipe ends of the first and second pipes;
welding the first and second pipe ends together to form the girth-weld;
disposing an expanded polymer-containing protective material over the girth-weld, wherein the polymer-containing protective material is bondable to the adhesion promoting end treatment material; and
shrinking the polymer-containing protective material over the girth-weld.

16. The method according to claim 15, wherein the disposing step comprises disposing an expanded heat recoverable material over the girth-weld, wherein the heat recoverable material is bondable to the adhesion promoting end treatment material.
